(19) United States
(12) Patent Application Publication
(10) Pub. No.: US 2005/0049876 A1
(43) Pub. Date: Mar. 3, 2005

(54) Method and apparatus for automatically identifying animal species from their vocalizations

(76) Inventor: Ian Agranat, Concord, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/767,801

(22) Filed: Jan. 29, 2004

Related U.S. Application Data
(60) Provisional application No. 60/498,507, filed on Aug. 28, 2003.

(51) Int. Cl. G10L 21/00

(52) U.S. Cl. 704/270

(57) ABSTRACT

Relatively powerful hand-held computing devices, Digital Signal Processors, Audio signal processing technology, voice recognition technology, expert systems, Hidden Markov Models, and/or neural networks are employed in a device capable of real-time automated species identification by listening to bird vocalizations in the field, analyzing their waveforms, and comparing these waveforms against known reference samples. An apparatus for identifying animal species from their vocalizations, comprises a source of digital signal representative of at least one animal candidate vocalization; a feature extractor that receives the digital signal, recognizes notes therein and extracts phrases including plural notes and that produces a parametric representation of the extracted phrases; and a comparison engine that receives the parametric representation of at least one of the digital signal and the extracted phrases, and produces an output signal representing information about the animal candidate based on a likely match between the animal candidate vocalization and known animal vocalizations. A computer-implemented method of identifying animal species, comprises: obtaining a digital signal representing a vocalization by a candidate animal; transforming the digital signal into a parametric representation thereof; extracting from the parametric representation a sequence of notes defining a phrase; comparing the phrase to phrases known to be produced by a plurality of possible animal species; and identifying a most likely match for the vocalization by the candidate animal based upon the comparison. The comparison engine or comparison function may use Hidden Markov Models, expert systems and/or neural networks.

### BACKGROUND

Naturalists and others often identify animal species in the field, initially, on the basis of their observable vocalizations.

Experienced bird watchers and naturalists have identified specific species of birds by their unique song vocalizations for centuries. Several hundred such songs have been documented in North America alone, and several books, tapes, and CDs have been published on the topic.

Amateur bird watchers, naturalists, students, and other interested parties may wish to identify birds by their songs in the field, but may not have the training, skill and experience necessary to do so effectively.

In addition, bird watchers may wish to know if particular species of birds have been present in an area without monitoring that area themselves for extended periods of time.

### SUMMARY OF THE INVENTION

In general, animal identification in the field, particularly bird watching, has not benefited much from advancement in technology. According to various aspects of embodiments of the present invention, relatively powerful hand-held computing devices, Digital Signal Processors, Audio signal processing technology, voice recognition technology, expert systems, Hidden Markov Models, and/or neural networks may be applied in the present invention to create a device capable of real-time automated species identification by listening to animal vocalizations in the field, particularly bird vocalizations, analyzing their waveforms, and comparing these waveforms against known reference samples.

According to some aspects of embodiments of the invention, an apparatus for identifying animal species from their vocalizations, comprises a source of digital signal representative of at least one animal candidate vocalization; a feature extractor that receives the digital signal, recognizes notes therein and extracts phrases including plural notes and that produces a parametric representation of the extracted phrases; and a comparison engine that receives the parametric representation of at least one of the digital signal and the extracted phrases, and produces an output signal representing information about the animal candidate based on a likely match between the animal candidate vocalization and known animal vocalizations. In a variation, the feature extractor comprises a transformer connected to receive the digital signal and which produces a digital spectrogram representing power and frequency of the digital signal at each point in time. In yet a further variation, the transformer comprises a Discrete Fourier Tansformer (DFT) having as an output signal a time series of frames comprising the digital spectrogram, each frame representing power and frequency data at a point in time. The power may be represented by a signal having a logarithmic scale. The frequency may be represented by a signal having a logarithmic scale. The power may be represented by a signal that has been normalized relative to a reference power scale. The frequency may be represented by a signal that has been normalized relative to a reference frequency scale. In another embodiment, the feature extractor further comprises a discrete cosine transform (DCT) transformer receiving the digital signal and producing a signal representing plural coefficients defining the parametric representation of the extracted phrases. In yet another embodiment, the feature extractor further comprises a transformer connected to receive the digital signal and which produces a signal defining a parametric representation of each note. The transformer may be a discrete cosine transform (DCT) transformer. The feature extractor may further comprise a time normalizer operative upon each note recognized in the digital signal before the transformer receives the digital signal. The comparison engine may further comprise a cluster recognizer that groups notes into clusters according to similar parametric representations. In such embodiments, the cluster recognizer may perform K-Means. The cluster recognizer may be a self-organizing map (SOM). The cluster recognizer may perform Linde-Buzo-Gray. In yet a further embodiment, the comparison engine further comprises a neural network trained to recognize likely matches between the animal candidate vocalization and the known animal vocalizations. The neural network may further comprise plural layers of processing elements arranged between an input of the comparison engine and an output of the comparison engine, including a Kohonen self-organizing map (SOM) layer. The neural network may further comprise plural layers of processing elements arranged between an input of the comparison engine and an output of the comparison engine, including a Grossberg layer. In yet further embodiments, the comparison engine further comprises a set of hidden Markov models (HMMs) excited by the parametric representation received, each HMM defined by a plurality of states. In such embodiments, at least one of the plurality of states comprises a data structure holding values defining a probability density function defining the likelihood of producing an observation. The probability density function may be a multi-variate Gaussian mixture. The multi-variate Gaussian mixture may be defined by a fixed co-variance matrix. An HMM of the set of HMMs may produce an observation corresponding to a bird species. An HMM corresponding to a set of training data representing at least one vocalization may comprise a first set of states representing a first cluster of time-normalized notes, classified according to similar parametric representations; and a second set of states representing a second cluster of time-normalized notes, classified according to similar parametric representations different from those of the first cluster of time-normalized notes. The HMM may further comprise a state corresponding to a gap between a note of the first cluster and a note of the second cluster. The set of training data may include coefficients from a discrete cosine transform (DCT) performed on a vocalization signal. The first cluster may comprise classification vectors clustered together using a K-Means process, a self-organizing map (SOM), or Linde-Buzo-Gray. The apparatus may further comprise a database of known bird songs. The database may include a data structure holding values in a memory of weights for a neural network. The database may also include a data structure holding values in a memory of parameters for a hidden Markov model (HMM). According to some aspects, the database may include a data structure holding records in a memory corresponding to the known bird songs specific to at least one of a region, a habitat, and a season. The database of known bird songs may be stored in a replaceable memory, such that the database of known bird songs can be modified by replacing the replaceable memory with a replaceable memory holding the modified database. The database of known bird songs may be stored in a modifiable memory. In such an embodiment, the apparatus may include a port, for example a wireless port, through which modifications to the database of known bird songs can be uploaded. The apparatus may further comprise a digital filter interposed between the source of a digital signal and the signal analyzer and classifier. The source may be a microphone. The source may further comprise an analog-to-digital converter connected to receive an analog signal from the microphone an to produce the digital signal. Where the source is a microphone, it may be a shotgun microphone, a parabolic microphone, an omnidirectional microphone, or an array of microphones. The array of microphones may be made directional by use of beam-forming techniques. The source may further comprise an analog signal input; and an analog-to-digital converter connected to receive a signal from the analog input, and producing the digital input signal. The performance of the apparatus may be such that a time from the signal transformer receiving the digital signal to the comparison engine producing the output signal is real-time.

According to yet another aspect of an embodiment of the invention, a computer-implemented method of identifying animal species, comprises: obtaining a digital signal representing a vocalization by a candidate animal; transforming the digital signal into a parametric representation thereof; extracting from the parametric representation a sequence of notes defining a phrase; comparing the phrase to phrases known to be produced by a plurality of possible animal species; and identifying a most likely match for the vocalization by the candidate animal based upon the comparison. Comparing may further comprise: applying a portion of the parametric representation defining the phrase to plural Hidden Markov Models defining phrases known to be produced by a plurality of possible animal species; and computing a probability that one of the plurality of possible animal species produced the vocalization by the candidate animal.

### BRIEF DESCRIPTION OF THE FIGURES

In the Figures, in which like reference designations indicate like elements:

FIG. 1 is a block diagram of an embodiment of aspects of the invention;

FIG. 2 is a representative spectrogram for a Black Capped Chickadee;

FIG. 3 is a representative spectrogram for a Cardinal;

FIG. 4 is a representative spectrogram for a Red Bellied Woodpecker;

FIG. 5 is a representative spectrogram for a Brown Thrasher;

FIG. 6 is a representative spectrogram for a Baltimore Oriole;

FIG. 7 is a block diagram of a computer system useful for embodying aspects of the invention; and

FIG. 8 is a block diagram of the storage subsystem of the computer system of FIG. 7.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “compromising,” or “having,” “containing,” “involving”, and variations thereof herein, is meant to encompass the items listed thereafter and equivalents thereof as well as additional items.

Embodiments of aspects of the invention include methods and apparatus which obtain a suitable signal for analysis; optionally clean up or preprocess the signal, for example by use of noise reduction processes; extract interesting features of the signal for further analysis; and, compare the extracted features to a database or the like of features corresponding to various known animal species. Using the structure and methods of the exemplary embodiment, real-time performance in the field can be achieved. That is, a species can be identified by the device in the field, while the observer using the device is still observing the animal that is vocalizing, in the field.

The methods and apparatus described herein are suitable for identifying many different species, including but not limited to birds, mammals, insects, etc. Examples are given without limitation, with respect to birds. For this reason, a term such as “note” or “phrase” should be read to include analogs pertaining to other animal families, such as “tone”, “phoneme,” etc.

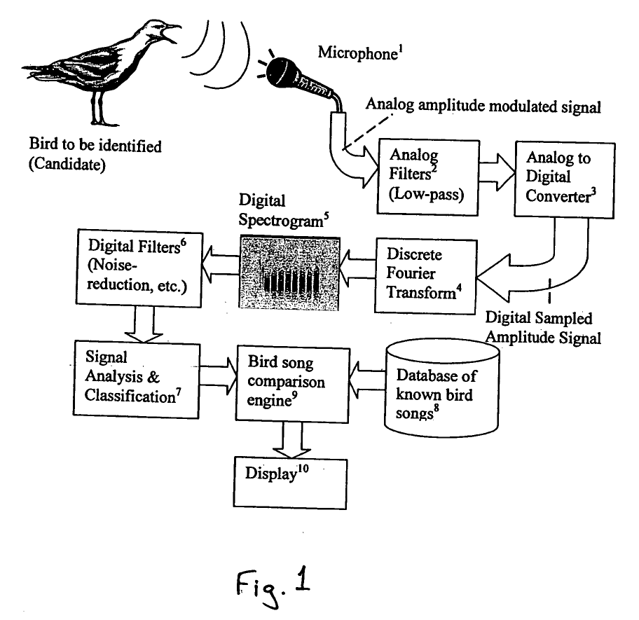

Embodiments of aspects of the present invention are described with reference to FIG. 1. Particular embodiments can be implemented in a portable hand-held device carried by the bird watcher. An exemplary device is equipped with a microphone (1) that responds to sounds in the environment. The microphone produces an analog amplitude-modulated signal which may then pass through various analog filters (2), for example, a low-pass filter to avoid picking up low frequency background noise. The analog signal is then digitized with an Analog-to-Digital (A/D) converter (3) to produce a digital signal representing samples of the original analog signal.

A Discrete Fourier Transform (DFT) (4) is performed on the digital signal using a Fast Fourier Transform (FFT) algorithm to convert the amplitude-modulated signal into the frequency domain to produce a digital spectrogram (5). The spectrogram is represented by a digital signal defining a 3-dimensional graph of time, frequency, and amplitude. Additional digital filters (6) may be applied to the spectrogram signal to further reduce background noise and enhance the signal strength of candidate bird vocalizations. The spectrogram signal is then analyzed (7) so as to extract information about suspected bird vocalizations that are necessary for identification. A comparison engine (9) attempts to match the candidate bird vocalization against a database (8) of known bird songs in order to make a positive identification. The result of the comparison is then sent to the display (10) indicating the likely species of bird, or birds, observed and the probability of a positive match, and possibly additional information about the bird such as a picture, migration patterns, typical song, habitat, etc.

The particular partitions of the functions of an embodiment shown in FIG. 1 may be varied without departing from the spirit of the invention. For example, the database of known bird songs (8) could be separate from the comparison engine (9), or could be embedded in the structure of the comparison engine and its logic. If integral with the comparison engine, the database could be embedded in a set of rules in an expert-system implementation of the comparison engine, or could be embodied in the weights to which neurons of a neural network have been programmed, or could be embodied in the parameters of Hidden Markov Models. In another partitioning variation, there may be separate structures for signal analysis and classification (7) and for the comparison engine (8), or they may be combined, or they may be intermingled in such a way as to cause some analysis to be performed before comparison and the balance to be performed after, or other suitable partitioning variations can be used. Furthermore, as explained below, several variations on the analyzer and comparison engine are contemplated, including, but not limited to, HMMs, neural networks and rules engines.

Microphone.

In one illustrative embodiment, the microphone is a modular unit that can be adapted for different situations. For example, a parabolic or shotgun directional microphone, or an array of more than one microphone using beam-forming techniques may be used if it is desirable, in the field, to focus on a specific candidate bird. Omnidirectional microphones may be desirable to capture a wide range of sounds in a particular area, such as when candidate birds are dispersed over a wide area. Different microphones may be better suited for harsh environmental conditions. Analog or digital auxiliary inputs can also be provided for analyzing previously recorded bird songs.

Analog Filters.

In the illustrative embodiment, low-pass and high-pass filters may be employed to help reduce noise. Most bird vocalizations can be observed in approximately a 1,200 Hz-8,000 Hz range. Use of low-pass and high-pass filters at the analog input stage can improve the quality of the signal being analyzed by removing portions unlikely to be part of a bird vocalization.

Analog to Digital Converter.

In the illustrative embodiment, the A/D converter may be integrated with a Digital Signal Processor (DSP) to combine low cost and powerful signal analysis capabilities. Because a Discrete Fourier Transform will be employed, and resolution in time and frequency is important in generating meaningful spectrograms, the sampling rate should be on the order of 16,000 samples per second. While lower sampling rates could produce meaningful spectrograms for some vocalizations, the smaller amount of information will reduce accuracy. There may be alternative digital sound sources that could be received for example by the digital auxiliary input or by some other input point, bypass the A/D converter and be received directly by the DFT engine. Alternative sound sources may be received through digital interfaces to other devices (e.g. the digital auxiliary input may be a USB port connected to a personal computer), or the alternative sound source may be one or more files stored on removable or fixed media (e.g. MP3 or WAV files on a removable FLASH card).

Discrete Fourier Transform.

In the illustrative embodiment, the DFT would be accomplished efficiently using a Fast Fourier Transform (FFT) algorithm on a Digital Signal Processor. However, the FFT algorithm can also be implemented in software on a general purpose microprocessor. With a sample rate of 16,000 per second at the A/D converter, a spectrogram with resolution of 0.016 seconds and 62.5 Hz is possible if each 256 samples are run through the FFT algorithm. Shaped windows can be used to reduce sampling and windowing effects further. For example, Discrete Fourier Transformer leakage can be reduced using overlapping Hanning windows. The resolution discussed herein is sufficient for bird song analysis. Higher sampling rates improve the resolution attainable and may improve the resolution attainable and may improve recognition accuracy.

Spectrogram.

The spectrogram is the output of a series of FFT operations on the input signal over time, with each operation producing a vector indicating power levels at various frequencies in the audio spectrum at a point in time. In one possible implementation, a number of vectors representing a period of time could be buffered in memory for further processing. In another possible implementation, processing could be performed in real time.

Digital Filters.

Common sources of noise can be identified and eliminated from the signal electronically using any suitable techniques, including those commonly applied to voice and telephony applications. Noise reduction can be achieved by measuring the background noise power levels in each discrete frequency bin produced by the FFT algorithm, and subtracting the background levels from the signal. This technique is commonly referred to as Spectral Subtraction. Echo cancellation techniques can also be applied to eliminate noise caused by the echo of vocalizations off objects such as trees, boulders, and man-made structures.

Signal Analysis and Classification Comparison Engine

The Signal Analysis and Classification function in the current invention analyzes the captured spectrogram and looks for individual waveforms suspected of being candidate vocalizations. This is easily done by looking for strong signals grouped tightly together. Then, these signals may optionally be compared with each other to look for repeating occurrences of individual phrases or notes. The phrases or notes and their characteristics are the extracted features of interest. The number of repetitions of each phrase or note, and the relationship from one phrase or note to the next, the specific waveform, and general characteristics like duration, frequency range, and spacing to other phrases or notes, is collected. A presently preferred embodiment employs phrases as the extracted feature.

The Bird Song Comparison Engine then applies the extracted features to an HMM, to a neural network or to rules stored in the database of known bird songs so as to make a determination of identification. As previously noted, the Signal Analysis and Classification block may be combined with the Comparison Engine.

One possible implementation of a comparison engine is a simple rules-based expert system that applies the rules from each bird to the sample, where the most easily identified references are checked first for quick matches, and more difficult identifications are applied last. Another possible implementation of a comparison engine is a neural network in which the collected characteristics are inputs to the neural network, and the rules are essentially embedded in the weights of the network that produce probabilities of a match for each known reference. Yet another possible implementation of a comparison engine is a collection of Hidden Markov Models in which the collected characteristics represent observation sequences, and the rules are essentially embedded in the parameters of each model that produce probabilities of a match for each known reference. This last approach, which is presently preferred, is described in greater detail in the discussion below of a prototype example. In that discussion, the observation sequences mentioned above are “phrases,” which are defined in terms of “notes,” which are themselves defined in terms of the signal present over time. As a practical matter, as described below, the signal is divided into frames. Each frame may be considered to be an “observation,” and each plurality of frames making up a phrase may be considered to be an “observation sequence,” whose parameters are also referred to as “features.”

These functional blocks may be implemented in software running on a DSP or a general purpose microprocessor. Depending on the signal being analyzed, this block may perform different functions. For some birds, waveform correlation is more effective, while for others, waveform characterization is more effective.

If the bird to be matched produces a sufficiently clear and distinct waveform, then waveform correlation using any suitable correlation algorithm or a neural network can be used. If a high enough correlation is produced with a waveform in the database, then the species can be deemed identified.

If no definite match can be produced for a waveform, then a rules-based analysis of waveform characteristics could identify birds having more complex vocalizations. Such analysis could examine such properties as frequency, shape, duration, repetition, spacing, attack and decay rates, etc. A more detailed discussion is presented below.

The Signal Analysis, Classification and Comparison blocks may be implemented in software running on a DSP or a general purpose microprocessor.

Feature Extraction

The engine first extracts features from the candidate vocalization that can then be used for comparison against the database of known bird vocalizations. The goal of feature extraction is to reduce the raw data representing the candidate vocalization into a meaningful set of parameters sufficient to differentiate between one species and another. There is a balance between being too specific and not specific enough. If too specific, the candidate vocalization may not be close enough to the correct vocalization as found in the database which may occur as many bird songs vary from individual to individual as well as regionally. If not specific enough, the candidate vocalization may be too close to one or more incorrect vocalizations in the database resulting in an incorrect match. The power spectrum data can be reduced effectively by converting from an absolute power scale to a logarithmic decibel scale. The frequency data can be reduced effectively by converting from a linear frequency scale to a logarithmic frequency scale. Finally, a discrete cosine transformation, for example according to the well-known DCT-II algorithm, of frequency and/or power data can further reduce the data to a compact and meaningful set of features suitable for comparison.

Feature Comparison

The engine scans the database for each known bird, and applies rules specific to each bird in an attempt to match the known bird with the candidate. The rules can take the form of parameters in a collection of Hidden Markov Models, a rules-based expert system, or weights and parameters in a neural network. The probability of positive identification is calculated, and the most probable match or matches are identified in an output signal. The output signal may be any suitable type of representation of the result. For example, the output signal may be a text string encoded in a digital electrical signal, or may be a digital electrical signal representing an image of the most likely match, or may be any other suitable signal. If the signal causes display of the result, for example on the display mentioned above, whether to display only one or to display more than one probable match is a design choice.

If implemented using a collection of Hidden Markov Models (HMMs), where each model represents a particular vocalization, correlation analysis can be performed by determining which HMM had the highest probability of generating the observed vocalization. In a Comparison Engine based on an expert system using rules, the rules for various different birds can be expressed by a set of concurrent state machines.

If implemented using deterministic computational methods, any such suitable method may be used to find close waveform correlations in the Database of Known Bird Songs. If implemented using a neural network, correlation analysis can be performed by a counter-propagation network with a Kohonen classification layer and a Grossberg output layer. The result produced by such a network is a single, best match, together with the likelihood that the match is correct.

An example of a difficult bird song to correlate might be that of a Northern Mocking Bird. The series of samples extracted from a Northern Mocking Bird song will typically correlate poorly with any bird, and what correlation can be found will jump from one bird to another. However, the Northern Mocking Bird will then be recognized by the combination of the lack of clear correlation and the presence of waveform characteristics such as number of repetitions of phrases or notes, rate of repetition of phrases or notes, sharpness of changes in frequency, duration, spacing, etc.

Database of Known Bird Songs

A database of known bird vocalizations is stored in the device. In some embodiments, this database can be upgraded to include new known bird songs, or customized for specific regions (e.g. “Eastern North America”). In one possible implementation, the database could be stored on a removable FLASH memory card. In yet another embodiment, the database could be stored in non-removable FLASH memory, and upgraded by connecting the device to a personal computer using a bus such as USB, or a local area network such as Ethernet or WiFi. In yet another embodiment, the database could be stored in non-removable FLASH memory, and upgraded by connecting to a telecommunications network using a local area network connection, or a dial-up modem connection. The database maps bird vocalizations to the names of specific species, but could also provide additional information to the bird watcher such as a picture of the bird and information about the bird's habitat, migration patterns, and other such information commonly found in birding books.

The database can take any convenient form, such as time sequences of DFT coefficients, time sequences of DCT coefficients, images of spectrograms, input waveforms, or the like.

The database contains the HMM model parameters for each HMM, as well as information about the species associated with the HMM. There may be several HMMs which in combination describe different vocalizations and their variations for a single species. HMM model parameters include a value for the number of states (to produce variable-length models), mean vectors for the Gaussian mixtures in each state, mixture probability coefficients, initial state probabilities, and a state transition probability matrix. As discussed elsewhere herein, there is no need to store covariance information since a fixed value is used for the covariance matrix.

A typical model contains an average of 9 states that can be represented in 72 mean vector elements (4 DCT coefficients times 2 mixtures times 9 states), 18 mixture probability coefficients (9 states times 2 mixtures per state), 9 initial state probabilities, and 81 (9 states squared) state transition probabilities, or 180 scalar values. With 16-bit fixed-point arithmetic, a typical model can fit in only 360 bytes. Greater compression is possible using well-known data compression algorithms.

In contrast, the raw digitized audio data representing a 6 second long phrase is typically 192,000 bytes (16,000 16-bit samples per second times 6 seconds). Furthermore, the original training data may represent a large number of phrases which are compressed into a single model.

The database can be upgraded with improved parameters, or with different sets of birds for different geographies, seasons, and/or habitats. Upgrades can be provided through a communication port, memory card or other I/O mechanism.

The database can be partitioned such that only birds from a given geography, season, and/or habitat as specified by user input (e.g. from a knob or other input device) would be selected.

Display/Speaker

The display could be any suitable display, for example a simple liquid crystal text display capable of indicating the name of identified birds and the probability of a strong match. More elaborate displays capable of graphics could also show the candidate and reference spectrograms, pictures of the reference bird, and additional information about the bird's habitat, migration patterns, etc.

It may be desirable for the device to play a bird's vocalization through a speaker. The HMM can be stimulated to generate observation sequences using a random number generator and the probabilities of the model. The generated DCT coefficient sequence can be smoothed out using well-known curve-fitting algorithms, inverted into frames of power and frequency values, and converted back into an amplitude-modulated digital signal using an inverse Fourier transform capable of driving a digital amplifier or digital-to-analog converter. Thus, bird songs can be generated without storing a large waveform.

Hardware Considerations

Various embodiments of aspects of the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor and especially hand-held computers based on the Motorola Dragonball series of processors or the ARM processors. The computer systems may be based on, or may include, a digital signal processor (DSP), such as Texas Instruments C55xx series or a Texas Instruments C54xx series DSP, or a DSP available from another manufacturer. It should be appreciated that one or more of any type computer system may be used to implement any part of the system according to various embodiments of aspects of the invention. Further, the system may be located on a single computer or may be distributed among a plurality of computers attached by a communications network.

A general-purpose computer system according to one embodiment of the invention is configured to perform each of the described functions, including but not limited to ______ the FFT, DCT, neural network and/or correlation function. It should be appreciated that the system may perform other functions, including network communication, and the invention is not limited to having any particular function or set of functions.

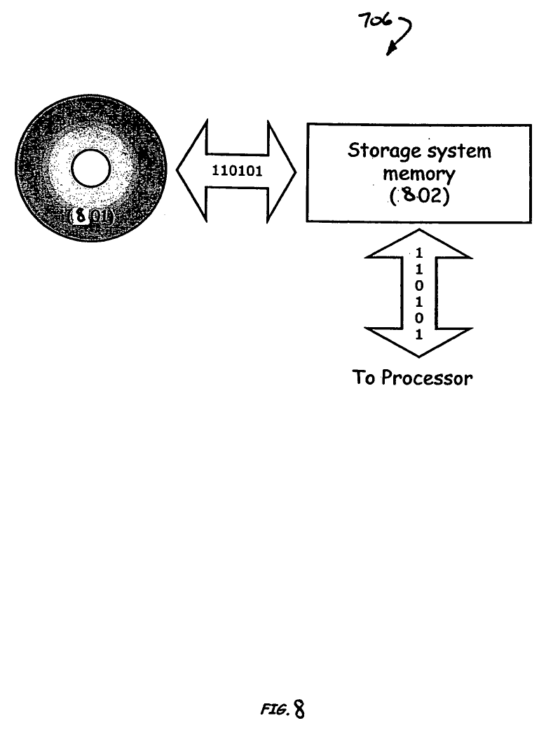

For example, various aspects of the invention may be implemented as specialized software executing in a general-purpose computer system 700 such as that shown in FIG. 7. The computer system 700 may include a processor 703 connected to one or more memory devices 704, such as solid state memory, or other any other suitable device for storing data. Memory 704 is typically used for storing programs and data during operation of the computer system 700. Components of computer system 700 may be coupled by an interconnection mechanism 705, which may include one or more busses (e.g., between components that are integrated within a same machine) and/or a network (e.g., between components that reside on separate discrete machines). The interconnection mechanism 705 enables communications (e.g., data, instructions) to be exchanged between system components of system 700.

Computer system 700 also includes one or more input devices 702, for example, a keyboard, mouse, trackball, the microphone discussed above, touch screen, and one or more output devices 701, for example, a printing device, display screen, speaker. In addition, computer system 700 may contain one or more interfaces (not shown) that connect computer system 700 to a communication network (in addition or as an alternative to the interconnection mechanism 705.

The storage system 706, shown in greater detail in FIG. 8, typically includes a computer readable and writeable nonvolatile recording medium 801 in which signals are stored that define a program to be executed by the processor or information stored on or in the medium 801 to be processed by the program. The medium may, for example, be a disk or flash memory. Typically, in operation, the processor causes data to be read from the nonvolatile recording medium 801 into another memory 802 that allows for faster access to the information by the processor than does the medium 801. This memory 802 is typically a volatile, random access memory such as a solid state dynamic random access memory (DRAM) or static memory (SRAM). It may be located in storage system 706, as shown, or in memory system 704. The processor 703 generally manipulates the data within the volatile memory 704, 802 and then copies the data to the medium 801 after processing is completed. A variety of mechanisms are known for managing data movement between the medium 801 and the integrated circuit memory element 704, 802, and the invention is not limited thereto. The invention is not limited to a particular memory system 704 or storage system 706.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 700 is shown by way of example as one type of computer system upon which various aspects of the invention may be practiced, it should be appreciated that aspects of the invention are not limited to being implemented on the computer system as shown in FIG. 7. Various aspects of the invention may be practiced on one or more computers having a different architecture or components than that shown in FIG. 7.

Computer system 700 may be a general-purpose computer system that is programmable using a high-level computer programming language. Computer system 700 may be also implemented using specially programmed, special purpose hardware. In computer system 700, processor 703 can be a commercially available processor such as the well-known Pentium class processor available from the Intel Corporation. Many other processors are available, as mentioned above, for example the TI C55xx or C54xx series DSPs. Such a processor may execute an operating system which may be, for example, the Windows 95, Windows 98, Windows NT, Windows 2000 (Windows ME) or Windows XP operating systems available from the Microsoft Corporation, MAC OS System X operating system available from Apple Computer, the Solaris operating system available from Sun Microsystems, or UNIX operating systems available from various sources. In the cases of computers based on the Dragonball or ARM processors, the Palm OS operating system available from Palm Source or the Windows Mobile 2003 for Pocket PC operating system available from Microsoft Corporation. Many other operating systems may be used, such as Linux, or no operating system may be used.

The processor and operating system (or lack) together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol. Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Other Considerations

Some embodiments may have a logging capability to store the time, location and species matched for later display, uploading, printing, saving, etc. Location can be entered by hand, by the knowledgeable birder, in some embodiments. Others can employ the Global Positioning System (GPS) satellite system or other location-finding mechanism to automatically log the location.

Some embodiments may use off-the-shelf hand-held computing devices and sound capture peripherals with custom software. Cost reduction is possible by creating an application specific embedded system powered by a commercially available DSP processor or a custom Application Specific Integrated Circuit (ASIC).

Training

Whether based upon an expert system, rules engine, neural network, or Hidden Markov Model, embodiments of aspects of the invention can include a learning capability. In the case of rules-based systems and expert systems, a skilled operator can indicate correct identification and/or characteristics to check, while collecting vocalizations in the field. New rules would then be generated and added to the rules base. In the case of a neural network or Hidden Markov Model, each identification tentatively made in the field can then be graded by a skilled operator to teach the neural network correct responses. During the grading process, new responses can also be introduced as new species are encountered. Rules based, neural network weights, or Hidden Markov Model parameters then developed can be downloaded by the manufacturer to improve a rules base or network weights preloaded on manufactured devices.

Example Identifications

There are several hundred species of bird native to any particular geographic region, each with unique vocalizations. For each specific bird, there are a handful of characteristics in the vocalization that can aide in identification. However, the specific characteristics helpful in identification will vary from species to species. Thus, each species may have specific rules for making a positive identification match with the candidate.

The identification of a Black Capped Chickadee, whose spectrogram is shown in FIG. 2, is now illustrated. Note that the Black Capped Chickadee is named for its unique vocalization which bird watchers would describe as sounding like “Chick-a-dee-dee-dee”. In the spectrogram of a Black Capped Chickadee vocalization, the “Chick”, “a”, and “dee-dee-dee” sounds can be clearly seen as notes with specific frequencies, durations, and relationship with each other. There will be variations, of course, among individual birds and individual songs that they utter. They may vary somewhat in pitch, over time, and the number of“dee-dee” repetitions may vary as well. One possible rule for identifying a Black Capped Chickadee may be the following:

“A short note at approximately 7,600 Hz, followed immediately by a second short note at approximately 6,700 Hz, followed by a series of 2 or more notes with durations of approximately 0.20 seconds at approximately 3,800 Hz”. A neural network comparing a sequence of samples from a candidate waveform to a known waveform for a Black Capped Chickadee inherently makes the comparison of this rule. Similarly, a Hidden Markov Model can describe the production of the observed sequence.

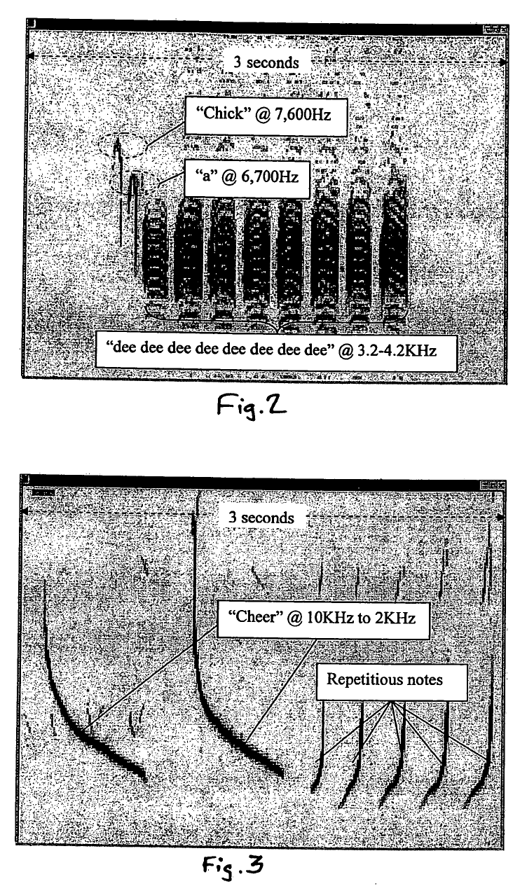

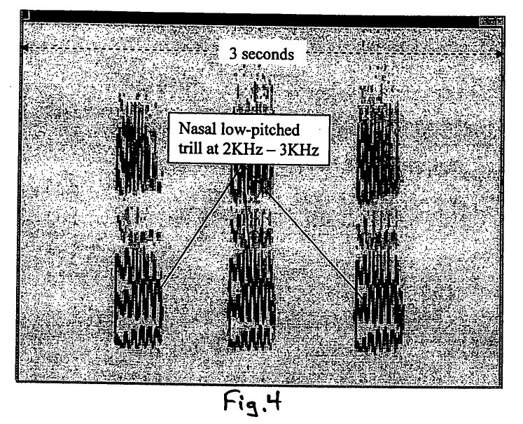

Another distinctive bird vocalization is that of the Cardinal, an example spectrogram of which is shown in FIG. 3. The Cardinal may be identified by a rule such as:

“One or two notes of about 700 ms each that each begin at about 10 kHz and slide continuously down to 2 kHz, followed by a series of about 2-5 repetitions of a 200 ms note rising from about 1 kHz to about 2 kHz.”

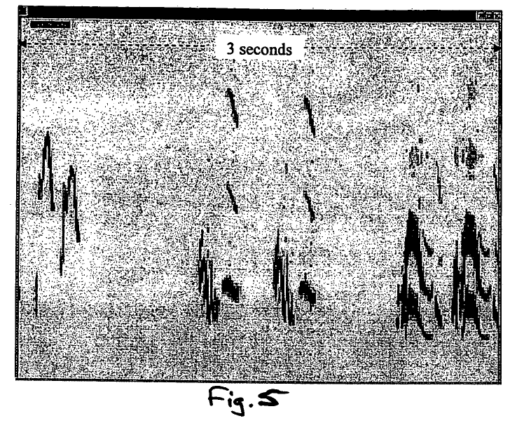

Yet another highly distinctive vocalization is that of a Red Bellied Woodpecker, an example spectrogram of which is shown in FIG. 4. A possible rule for identifying this bird may be:

“Three repetitions of a trilled note approximately 250 ms long and between I kHz and 2 kHz.”

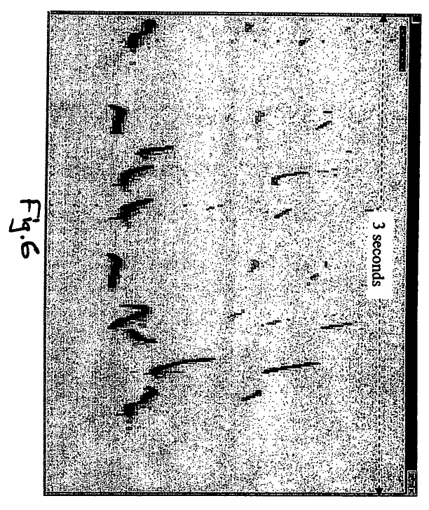

Identification of the Black Capped Chickadee, Cardinal and Red Bellied Woodpecker is fairly straightforward, as illustrated by the above rules. While many bird species are similarly easily identified by their specific repeating song patterns, other bird species have somewhat variable songs and need to be identified using different rules. For example, the Northern Mocking Bird has a song that typically incorporates notes at several different frequencies, but can be identified by the fact that these notes are relatively short in duration and are repeated 3 or more times in a row before changing. Similarly, the Brown Thrasher incorporates several different frequencies, but can be identified by the fact that these notes repeat twice in a row before changing. See FIG. 5.

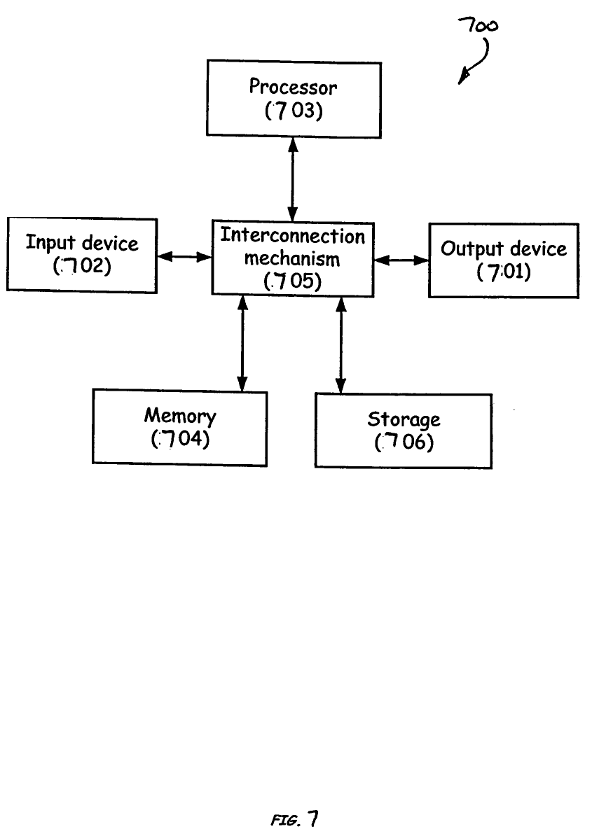

In yet more complex example, the spectrogram of the Baltimore Oriole is shown in FIG. 6. The song of the Baltimore Oriole is quite variable within an individual bird's repertoire, and also from individual to individual. However, duration of notes, sustained areas of fixed frequencies, attack and decay rates, general frequency range and other waveform characteristics can distinguish this spectrogram from those of other birds.

Prototype Embodiments

Prototypes based on 1) HMMs, 2) neural networks, and 3) expert systems have been constructed. Concepts from each of these embodiments can be combined where suitable and desirable to optimize the performance of the combination.

Approaching Using HMMs to Match Phrases

A working prototype embodying aspects of the invention discussed above using HMMs to match phrases has been realized. In this prototype, the observations to be processed by the HMM, i.e. the features extracted from each bird call, are vectors containing the first few DCT-II coefficients of the log power values across a log-warped frequency spectrum for a given short window of time. An observation sequence is a “phrase,” defined as a series of “notes” occurring close together in time. A “note” is defined as a period of time during which the signal amplitude is sustained above some threshold delimited by lack of signal or signal below some threshold.

Skilled artisans in automated bird recognition have not recognized that “phrases” represent a unit of signal appropriate in solving the species classification problem. Common, is the use of sinusoids, or of waveform correlation, which is a primitive version of note classification.

It has been observed that bird vocalizations consist of small bursts of acoustic energy referred to as “notes”. A tight grouping of “notes” forms a “phrase”. Some birds have only one note, where groupings of the note into a phrase relates to the tempo and repetitiousness of the vocalization; other birds have a limited set of notes that are arranged into phrases in different ways; and still other birds have great variability in notes. Looking at individual notes fails to classify birds effectively in the second two cases. Looking at phrases, however, can very effectively classify birds in the first two cases. For the third case, HMMs perform well by looking at how notes are formed, even variably.

Bird vocalizations consist of notes organized into phrases. For the purpose of the prototype, a note is described as a series of contiguous signal frames preceded and followed by background frames. A phrase is described as a series of notes with no more than 24 contiguous background frames (0.384 s). Phrases longer than 372 frames are truncated to be less than or equal to 372 frames, where the last frame is selected to be the frame immediately preceding a background frame.

One difficult aspect of creating an effective HMM for recognition is developing an initial model. It is fairly common in speech recognition applications to take a word or phoneme to be recognized, divide the word or phoneme into fixed-length time slices, and assign each time slice to a state.

In bird vocalizations, the “words” or “phonemes” of a particular species of bird are not known. A bird phrase may contain many different notes, some of which may be repeated, and separated by a gap between notes. If a phrase was simply arbitrarily cut into frames, without paying attention to the delimiting gaps, then there would be states containing both gaps and signal. Further, it would be difficult to capture the repetition of notes within a phrase if different states were assigned arbitrarily to signal throughout the phrase.

It has been found that it is better to classify the notes within phrases across the training data so that notes that repeat can be recognized. Different instances of the same repeating note should be assigned to the same set of states. And gaps should also be assigned to states. In order to capture some of the bird's syntax of how notes are arranged, different gap states are assigned to the gaps following different notes.

For example, referring to a common Cardinal “cheer” vocalization as depicted in FIG. 3, there are two classes of notes: the long downslurred note (shown with two repetitions); followed by several shorter upslurred notes, comprising a phrase. A training set of many Cardinal “cheer” vocalizations may show some with different repetitions, variant in duration and pitch, but all characterized by roughly the same set of two notes.

As described herein, a 2-dimensional DCT-II is performed on a time-normalized note to generate a note classification vector for each note across the training data. Then, the notes are clustered into groups with similar properties by performing K-Means. In this example, two clusters are identified, one for the long downslurred note, and one for the short upslurred note. The same set of states are then assigned to each downslurred note, and a different set of states to each upslurred note. The gaps following the downslurred note are assigned to yet another state, and the gaps following the upslurred note are assigned yet again to a different state.

Now, meaningful Gaussian mixtures for the states are calculated because like portions of like notes are compared.

The prototype is described below.

The input digital sound signal is sampled at a rate of 16,000 sample/second with 16-bit resolution. As previously noted, there may be sufficient information with slower sampling rate and smaller number of bits/sample. First, the system performs a 256 DFT using hamming window, and averaging two overlapping windows together (spaced 128 samples apart) to get the power spectrum across 128 frequencies (62.5 Hz each) in a 0.016 s wide frame.

Next, the 128 linear frequency bins are mapped into 32 logarithmic frequencies similar to the Mel scale used in voice recognition. But whereas Mel prefers frequencies below 1 KHz, the present embodiment prefers a higher range of frequencies. Converting a frequency f in Hz to Mel scale M, the formula M=1127.01048 log (1+f/700) is used. Instead, in the embodiment, the formula M′=16 log (1+(f−1187.5)/1066.3). This ignores frequencies below 1187.5 Hz (the first 19 of 128 DFT bins, mapping bins 19-128 to 0-31. The embodiment uses triangular windows with peaks at the mid-point of each M′ to average values from the DFT into the mapped frequency bins. Any other suitable window shape can also be used, such as simple rectangular windows, as well as other shapes. Note that there are some birds with unusually low frequency vocalizations, such as the mourning dove and several species of owl, that fall below 1187.5 Hz (some as low as 150 Hz). Different log scales can be used to trade off between recognizing birds with low frequency vocalizations and eliminating low frequency noise.

Background noise levels are determined by maintaining a rolling average and peak power level for each mapped frequency bin over a 6 frame (0.096 s) window of time. When this rolling average reaches a minimum over a 96 frame (1.53 s) period, it is assumed to be representative of background noise levels. The mean background noise level is subtracted from each frame across the mapped frequency bins (Spectral Subtraction) to increase the signal-to-noise ratio. Each frame is then marked as either a signal frame or a background frame based upon the relationship of power levels to some threshold based on the observed peak background level in any of the mapped frequency bins.

Power levels for each mapped frequency bin of each frame in the phrase is converted from an absolute power scale to a logarithmic decibel scale normalized such that the peak power in any given frame is 0 dB, and power levels below −15 dB are set to −15 dB. All mapped frequency bins of background frames are set to −15 dB. Note that many bird vocalizations have interesting spectral characteristics down below −35 dB. However, experimentation suggests that there is sufficient resolution at −11 dB for the purposes of identification, and better real world matching performance can be achieved by reducing the necessary signal to noise ratio as low as possible.

A Discrete Cosine Transform (DCT-II) is performed on each frame in the phrase, and the first four (0-4) coefficients are saved. Note that the above steps can be performed in real time resulting in a buffer containing up to 372 sets of 4 DCT-II coefficients representing a vocalization of a candidate bird.

Each frame of 4 DCT-II coefficients represents an observation of a Hidden Markov Model, and the set of frames comprising the phrase represents a variable-length observation sequence. The database of known bird vocalizations comprises parameters for a set of Hidden Markov Models in which there are one or more Hidden Markov Models for each vocalization. Some birds may have many vocalizations, and each vocalization may have more than one variation (e.g. typical regional or individual variations), each represented by a different Hidden Markov Model. Also, rather than discrete symbols, the prototype makes use of continuous Gaussian probability densities with multiple mixtures per state. Alternative implementations may use some form of vector quantization such as Linde-Buzo-Grey or K-Means to convert the DCT coefficients into a set of discrete symbols.

When using Gaussian mixtures, it is common to define a mean vector and a co-variance matrix to describe a multivariate Gaussian distribution. When there is a large amount of training data, good values for the mean and co-variance matrix can be calculated. However, when there is insufficient training data, the calculation of variance can easily be too large or too small. When used in HMMs, an incorrectly large variance value will artificially increase the probability that a given observation occurs in a state resulting in false positives, while an incorrectly small variance value will artificially decrease the probability that a given observation occurs in a state resulting in false negatives. Since only a limited number of bird song recordings are readily available, compared to the large variety among individuals within a species, there is often insufficient training data available for reliable calculation of co-variance matrices.

Instead, this exemplary embodiment uses a fixed value for the co-variance matrix optimized for maximum recognition performance across the set of HMMs. A beneficial side effect is that there is no need to store co-variance matrices among the HMM parameters thus reducing the size of the database.

The Viterbi algorithm is used to calculate the probabilities that each of the Hidden Markov Models generated the observation sequence. The probability of each model can be updated incrementally in real-time without the need to buffer the entire vocalization if there is sufficient processing power. The model with the highest probability indicates the likely identification, and other similarly high probabilities may indicate alternative possibilities.

During training, the following method can create the Hidden Markov Model associated with a known bird vocalization. Ideally, several different observation sequences of the vocalization are available from a diverse and representative variety of the species. First, the method assigns each observation to a state. This is done by classifying individual notes by type, and dividing each instance of a note class into a uniform set of states. One additional state is used to represent background frames that follow the note class, if any. For note classification, each note is normalized to a 32 frame by 32 mapped frequency bin grid, and a 2D DCT-II is performed. A note feature vector is created from the original duration of the note and normalized, plus the 5 2D DCT-II coefficients (0,1), (0,2), (1,0), (1,1), and (2,0). These feature vectors are then divided into clusters using the K-Means algorithm. The number of initial clusters is set to 4 by default, but may be adjusted for each HMM to optimize for maximum recognition performance. The clusters represent unique classes of notes, and each note matching the class is divided evenly into states such that, on average, there are 6 frames per state. For each state, each observation vector is clustered into up to 2 mixtures (using the K-Means algorithm again). The mean observation vector for each cluster and corresponding covariance matrix is saved. Mixture coefficients, state transition probabilities, and initial state probabilities are calculated from the observation sequence and state assignments. The result is an initial estimate of a Hidden Markov Model. Next, the model is iteratively refined by running the Viterbi algorithm for each observation sequence, noting the state sequence and mixtures chosen. Updated mixture mean vectors, covariance matrices, coefficients, state transition probabilities, and initial state probabilities are recalculated. This process is repeated until no further improvement in the resulting model probability occurs. Note that diagonal covariance matrices are used to simplify computation. Also note that for insufficient training data, variances can tend to be too large (in which case incorrect observations result in high probabilities leading to false matches), or too small (in which case correct observations result in low probabilities leading to incorrect matches). Through experimentation, a fixed variance of 2.5 for each dimension was found to be effective. Finally, note that minimum state transition probabilities, initial state probabilities, and mixture coefficients of 0.0001 are used to improve the matching of variations and noisy samples.

Preliminary testing of the prototype was conducted as follows starting with high quality digitized recordings of 45 vocalizations from 25 species, each between 10 and 30 seconds in duration. The recordings were broken up into two groups, A and B, such that the first 3 seconds of each of the 45 vocalizations is in group A, and the remaining portion of each sample is in group B. Hidden Markov Models trained using the smaller training data set in group A were able to correctly identify all of group A and 39 out of 45 of group B. Hidden Markov Models trained using the larger training data set in group B was able to correctly identify all 45 of 45 from both groups A and B. In another test, 105 vocalizations from 57 species (including 3 mammals) were used to train HMMs with all 105 recognized from the training data (correctly matching 1051 out of 1097 phrases from the training data exceeding 95% accuracy).

Approach Using Expert System to Match Notes

According to another approach, the Comparison Engine scans the database for each known bird, and applies rules specific to each bird in an attempt to match the known bird with the candidate. The rules can take the form of a rules-based expert system. The probability of positive identification is calculated, and the most probable match or matches are displayed. Whether to display only one or to display more than one probable match is a design choice.

In a Comparison Engine based on an expert system using rules, the rules for various, different birds can be expressed by a set of concurrent state machines. A big state machine with built-in error states for missed signal and/or inserted noise, matches samples of a bird song to be identified to a dictionary of recognizable samples. The set of all samples across species that are used as an aide to identification are analogous to a list of phonemes. And the individual songs or song patterns that birds sing (at least for those with well organized and consistent songs) would make up a dictionary that drives a large state machine to match songs. This will work well for the well-defined songs or sequences of notes (noting that some birds chirp a specific note, but the note has very specific characteristics in shape that can be matched). Where no match can be found, then special-case rules can be applied to classify the birds with more random songs, based on other qualities such as duration of notes, slopes of pitch changes, frequency of oscillations, spacing, repetition of notes or phrases, etc.

If implemented using deterministic computational methods, any such suitable method may be used to find close waveform correlations in the Database of Known Bird Songs. Each sample, referred to above, is reduced to an input vector for the correlation process. The input vectors can comprise triplets including time, main frequency, and peak amplitude. Each input vector could represent the average values over a sliding window of about 200-300 ms, for example. Thus, each sample is 200-300 ms slice of the waveform captured. The input vector can be normalized against an entry in the Database of Known Bird Songs for time and frequency by any suitable technique. When a series of samples tend to correlate with only one entry in the Database, a probable match has been found. Otherwise, waveform characterization may be used to identify species that do not produce easily correlated songs.

Approach Using Neural Networks to Match Notes

According to yet another approach that has been tested, the comparison engine employs a neural network in which the rules of comparison are embodied in the weights, parameters and topology of the network. The neural network produces a single output indicating the best match for the input.

A similar technique to that used for note classification in training an HMM can also be used for recognition by defining a feature vector that is good at describing a “note” and has had some success when used with neural networks.

If implemented using a neural network, correlation analysis can be performed by a counter-propagation network with a Kohonen classification layer and a Grossberg output layer. The result produced by such a network is a single, best match, together with a likelihood that the match is correct.

A feature vector describing the frequency power spectrum observed in a short window of time can be constructed as described previously and represented as a vector of a few DCT-II coefficients. These vectors can be input to a time-delayed Neural Network (TDNN) using a time-spreading algorithm, for temporal normalization, to generate a pattern representing the vocalization.

Alternatively, a feature vector describing the frequency power spectrum of a note normalized in time can be constructed as described previously and represented as a vector containing a normalized note duration together with a set of 2D DCT-II coefficients. Such a feature vector could be input to a Neural Network to generate a pattern representing each note of a vocalization. The notes can be classified by a Kohonen self-organizing map. Notes of particular matching shapes may occur in a given vocalization with a probability distribution that can be learned by a Grossberg output layer. By accumulating probabilities of notes as they occur through a vocalization consisting of several notes, one or more candidate bird species may be identified. Recognition performance can be further improved by adding inhibitor weights such that the probability of a match decreases in the presence of certain notes. This technique works fairly well for species with predictable notes and phrases, but does not perform well when there is more variability in the bird song.

Combinations

In each of the three approaches described above, there may be bird songs that are particularly difficult to identify. Because the different approaches each have their own strengths, they may be advantageously combined to identify a broad range of bird songs. For example, a neural network can be combined with a rules-based expert systems approach to advantageously identify differently characterized bird songs, as discussed above.

The present invention has been described relative to an illustrative embodiment. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

1. Apparatus for identifying animal species from their vocalizations, comprising:
a source of digital signal representative of at least one animal candidate vocalization;
a feature extractor that receives the digital signal, recognizes notes therein and extracts phrases including plural notes and that produces a parametric representation of the extracted phrases; and
a comparison engine that receives the parametric representation of at least one of the digital signal and the extracted phrases, and produces an output signal representing information about the animal candidate based on a likely match between the animal candidate vocalization and known animal vocalizations.

2. The apparatus as claimed in claim 1, wherein the feature extractor comprises:
a transformer connected to receive the digital signal and which produces a digital spectrogram representing power and frequency of the digital signal at each point in time.

3. The apparatus as claimed in claim 2, wherein the transformer comprises:
a Discrete Fourier Tansformer (DFT) having as an output signal a time series of frames comprising the digital spectrogram, each frame representing power and frequency data at a point in time.

4. The apparatus as claimed in claim 2, wherein the power is represented by a signal having a logarithmic scale.

5. The apparatus as claimed in claim 2, wherein the frequency is represented by a signal having a logarithmic scale.

6. The apparatus as claimed in claim 2, wherein the power is represented by a signal that has been normalized relative to a reference power scale.

7. The apparatus as claimed in claim 2, wherein the frequency is represented by a signal that has been normalized relative to a reference frequency scale.

8. The apparatus as claimed in claim 1, wherein the feature extractor further comprises a discrete cosine transform (DCT) transformer receiving the digital signal and producing a signal representing plural coefficients defining the parametric representation of the extracted phrases.

9. The apparatus as claimed in claim 1, wherein the feature extractor further comprises:
a transformer connected to receive the digital signal and which produces a signal defining a parametric representation of each note.

10. The apparatus as claimed in claim 9, wherein the transformer is a discrete cosine transform (DCT) transformer.

11. The apparatus as claimed in claim 9, wherein the feature extractor further comprises:
a time normalizer operative upon each note recognized in the digital signal before the transformer receives the digital signal.

12. The apparatus as claimed in claim 9, wherein the comparison engine further comprises:
a cluster recognizer that groups notes into clusters according to similar parametric representations.

13. The apparatus as claimed in claim 12, wherein the cluster recognizer performs K-Means.

14. The apparatus as claimed in claim 12, wherein the cluster recognizer is a self-organizing map (SOM).

15. The apparatus as claimed in claim 12, wherein the cluster recognizer performs Linde-Buzo-Gray.

16. The apparatus as claimed in claim 1, wherein the comparison engine further comprises:
a neural network trained to recognize likely matches between the animal candidate vocalization and the known animal vocalizations.

17. The apparatus as claimed in claim 16, wherein the neural network further comprises:
plural layers of processing elements arranged between an input of the comparison engine and an output of the comparison engine, including a Kohonen self-organizing map (SOM) layer.

18. The apparatus as claimed in claim 16, wherein the neural network further comprises:
plural layers of processing elements arranged between an input of the comparison engine and an output of the comparison engine, including a Grossberg layer.

19. The apparatus as claimed in claim 1, wherein the comparison engine further comprises:
a set of hidden Markov models (HMMs) excited by the parametric representation received, each HMM defined by a plurality of states.

20. The apparatus as claimed in claim 19, wherein at least one of the plurality of states comprises:
a data structure holding values defining a probability density function defining the likelihood of producing an observation.

21. The apparatus as claimed in claim 20, wherein the probability density function is a multi-variate Gaussian mixture.

22. The apparatus as claimed in claim 21, wherein the multi-variate Gaussian mixture is defined by a fixed co-variance matrix.

23. The apparatus as claimed in claim 19, wherein an HMM of the set of HMMs produces an observation corresponding to a bird species.

24. The apparatus as claimed in claim 19, wherein an HMM corresponding to a set of training data representing at least one vocalization comprises:
a first set of states representing a first cluster of time-normalized notes, classified according to similar parametric representations; and
a second set of states representing a second cluster of time-normalized notes, classified according to similar parametric representations different from those of the first cluster of time-normalized notes.

25. The apparatus as claimed in claim 24, wherein the HMM further comprises:
a state corresponding to a gap between a note of the first cluster and a note of the second cluster.

26. The apparatus as claimed in claim 24, wherein the set of training data includes coefficients from a discrete cosine transform (DCT) performed on a vocalization signal.

27. The apparatus as claimed in claim 24, wherein the first cluster comprises classification vectors clustered together using a K-Means process.

28. The apparatus as claimed in claim 24, wherein the first cluster comprises classification vectors clustered together using a self-organizing map (SOM).

29. The apparatus as claimed in claim 24, wherein the first cluster comprises classification vectors clustered together using Linde-Buzo-Gray.

30. The apparatus as claimed in claim 1, further comprising a database of known bird songs.

31. The apparatus as claimed in claim 30, wherein the database comprises:
a data structure holding values in a memory of weights for a neural network.

32. The apparatus as claimed in claim 30, wherein the database comprises:
a data structure holding values in a memory of parameters for a hidden Markov model (HMM).

33. The apparatus as claimed in claim 30, wherein the database comprises:
a data structure holding records in a memory corresponding to the known bird songs specific to at least one of a region, a habitat, and a season.

34. The apparatus as claimed in claim 30, wherein the database of known bird songs is stored in a replaceable memory, such that the database of known bird songs can be modified by replacing the replaceable memory with a replaceable memory holding the modified database.

35. The apparatus as claimed in claim 30, wherein the database of known bird songs is stored in a modifiable memory.

36. The apparatus as claimed in claim 35, wherein the apparatus includes a port through which modifications to the database of known bird songs can be uploaded.

37. The apparatus as claimed in claim 36, wherein the port is wireless.

38. The apparatus as claimed in claim 1, further comprising:
a digital filter interposed between the source of a digital signal and the signal analyzer and classifier.

39. The apparatus as claimed in claim 1, wherein the source further comprises:
a microphone.

40. The apparatus as claimed in claim 39, wherein the source further comprises:
an analog-to-digital converter connected to receive an analog signal from the microphone an to produce the digital signal.

41. The apparatus as claimed in claim 39, wherein the microphone further comprises:
a shotgun microphone.

42. The apparatus as claimed in claim 39, wherein the microphone further comprises:
a parabolic microphone.

43. The apparatus as claimed in claim 39, wherein the microphone further comprises:
an omnidirectional microphone.

44. The apparatus as claimed in claim 39, wherein the microphone further comprises:
an array of microphones.

45. The apparatus as claimed in claim 44, wherein the array of microphones is made directional by use of beam-forming techniques.

46. The apparatus as claimed in claim 1, wherein the source further comprises:
an analog signal input; and
an analog-to-digital converter connected to receive a signal from the analog input, and producing the digital input signal.

47. The apparatus as claimed in claim 1, wherein a time from the signal transformer receiving the digital signal to the comparison engine producing the output signal is real-time.

48. A computer-implemented method of identifying animal species, comprising:
obtaining a digital signal representing a vocalization by a candidate animal;
transforming the digital signal into a parametric representation thereof;
extracting from the parametric representation a sequence of notes defining a phrase;
comparing the phrase to phrases known to be produced by a plurality of possible animal species; and
identifying a most likely match for the vocalization by the candidate animal based upon the comparison.

49. The method of claim 48, wherein comparing further comprises:
applying a portion of the parametric representation defining the phrase to plural Hidden Markov Models defining phrases known to be produced by a plurality of possible animal species; and
computing a probability that one of the plurality of possible animal species produced the vocalization by the candidate animal.
